(19) United States
(12) Patent Application Publication
(10) Pub. No.: US 2022/0172197 A1
(43) Pub. Date: Jun. 2, 2022

(54) SYSTEMS AND METHODS FOR INLINE PASSIVE PAYMENT WITH ANONYMOUS SHIPPING

(71) Applicant: JPMORGAN CHASE BANK, N.A., New York, NY (US)

(72) Inventor: Howard SPECTOR, Woolwich, NJ (US)

(21) Appl. No.: 17/456,703

(22) Filed: Nov. 29, 2021

Related U.S. Application Data
(60) Provisional application No. 63/120,118, filed on Dec. 1, 2020.

(51) Int. Cl. G06Q 20/38; G06Q 20/40; G06Q 20/12

(52) U.S. Cl. CPC G06Q 20/383; G06Q 20/12; G06Q 20/401

(57) ABSTRACT

A method for inline passive payment may include a passive payment computer program: (1) identifying a communication from an electronic device associated with a customer for a merchant backend; (2) intercepting the communication; (3) generating a unique identifier for the communication; (4) communicating the unique identifier to an issuer backend associated with the customer; (5) anonymizing the customer and/or the electronic device in the communication; and (6) routing the anonymized communication to the merchant backend with the unique identifier. The wherein the merchant backend is configured to request payment for a transaction involving the electronic device by providing transaction information and the unique identifier to the issuer backend, and the issuer backend is configured to issue a guarantee of payment for the merchant backend for the transaction using the unique identifier.

### RELATED APPLICATIONS

This application claims priority to, and the benefit of, U.S. Provisional Patent Application Ser. No. 63/120,118, filed Dec. 1, 2020, the disclosure of which is hereby incorporated, by reference, in its entirety.

### BACKGROUND OF THE INVENTION

### 1. Field of the Invention

Embodiments are generally related to systems and methods for inline passive payment with anonymous shipping.

### 2. Description of the Related Art

Traditionally, when conducting an online transaction, a customer browses a merchant's website or application, and adds items to a basket or shopping cart. The customer then uses the merchant's checkout flow to make the purchase. The merchant, and any eavesdropper, is able to glean the customer's shipping address, phone number, and possibly more from this interaction.

### SUMMARY OF THE INVENTION

Systems and methods for inline passive payment with anonymous shipping are disclosed. According to an embodiment, a method for inline passive payment may include: (1) identifying, at a passive payment service computer program, a communication from an electronic device associated with a customer for a merchant backend; (2) intercepting, by the passive payment service computer program, the communication; (3) generating, by the passive payment service computer program, a unique identifier for the communication; (4) communicating, by the passive payment service computer program, the unique identifier to an issuer backend associated with the customer; (5) anonymizing, by the passive payment service computer program, the customer and/or the electronic device in the communication; and (6) routing, by the passive payment service computer program, the anonymized communication to the merchant backend with the unique identifier. The merchant backend may be configured to request payment for a transaction involving the electronic device by providing transaction information and the unique identifier to the issuer backend, and the issuer backend is configured to issue a guarantee of payment for the merchant backend for the transaction using the unique identifier.

In one embodiment, the passive payment service computer program may be executed by a network provider comprising a mobile network operator or by a network provider comprising an internet service provider. The passive payment service computer program may include a browser plugin for a browser executed on the electronic device. The browser plugin may injects the unique identifier into a header of a http(s) request from the browser to the merchant backend.

According to another embodiment, an electronic device may include a memory storing a passive payment service computer program and computer processor. When executed by the computer processor, the passive payment service computer program causes the computer processor to: identify a communication from an electronic device associated with a customer for a merchant backend; intercept the communication; generate a unique identifier for the communication; communicate the unique identifier to an issuer backend associated with the customer; anonymize the customer and/or the electronic device in the communication; and route the anonymized communication to the merchant backend with the unique identifier.

In one embodiment, the electronic device may be part of a network provider comprising a mobile network operator, or it may be part of a network provider comprising an internet service provider.

In one embodiment, the passive payment service computer program may include a browser plugin for a browser executed on the electronic device. The browser plugin may inject the unique identifier into a header of a http(s) request from the browser to the merchant backend.

According to another embodiment, a system may include an electronic device, a network provider comprising a passive payment service computer program, a merchant backend, and an issuer backend comprising an passive payment computer program and authorization computer program. The passive payment service computer program identifies a communication from the electronic device associated with a customer for the merchant backend, intercepts the communication; generates a unique identifier for the communication; communicates the unique identifier to an issuer backend associated with the customer; stores an association between customer information for the customer and the unique identifier; anonymizes the customer and/or the electronic device in the communication; and routes the anonymized communication to the merchant backend with the unique identifier. The authorization computer program receives, from the merchant backend via a payment network, an authorization request for a transaction comprising transaction information and the unique identifier; retrieves the customer information associated with the unique identifier decisions the authorization request; and provides a payment guarantee for the transaction to the merchant backend. The merchant backend completes the transaction.

In one embodiment, the passive payment computer program further communicates shipping information to the merchant backend. The shipping information may include anonymized shipping information. The anonymized shipping information may include a third-party address.

In one embodiment, the electronic device is part of a network provider comprising a mobile network operator, or part of a network provider comprising an internet service provider.

In one embodiment, the passive payment service computer program may include a browser plugin for a browser executed on the electronic device. The browser plugin may inject the unique identifier into a header of a http(s) request from the browser to the merchant backend.

In one embodiment, the system may include a second electronic device that is registered to the customer, wherein the second electronic device completes the transaction initiated with the electronic device. The second electronic device may be registered to a family member of the customer.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for inline passive payment with anonymous shipping according an embodiment; and

FIG. 2 depicts a method for inline passive payment with anonymous shipping according an embodiment.

### DETAILED DESCRIPTION OF PREFERRED EMBODIMENTS

Systems and methods for inline passive payment with anonymous shipping are disclosed. In embodiments, a passive payment service may change the transaction flow, enabling a true zero touch checkout in real-time or even at a later date (e.g., the later completion of a saved transaction, such as items in the customer's shopping cart). During the shopping process, the customer may be a guest or logged in to the merchant. The merchant may then receive a notice from the issuer's passive payment system indicating that the customer—who may be anonymous to the merchant—has sufficient funds to cover the purchase. In embodiments, this may be enabled by the passive payment system, which knows the customer and uses one or more unique identifier to communicate with the merchant. For example, as the cart is populated, the customer may select an option to complete the transaction with the passive payment system.

In embodiments, the customer may also close the browser, and at a later time, may compete the transaction. For example, the customer may “ask” an IoT device, such as a smart speaker, to complete the purchase with XYZ merchant. The passive payment system may receive this message from the IoT device and then ping the merchant with the unique identifier used for the last interaction on the site. The merchant will use the unique identifier to complete the payment process.

The payment process may involve the merchant pulling back the credit card number, name and address information and running the transaction, or the merchant may use the unique identifier and call the issuer to complete the checkout without using a credit card number. The issuer would still return the name and address information needed for shipping, such as an anonymous shipping address, a customer pickup code, etc.

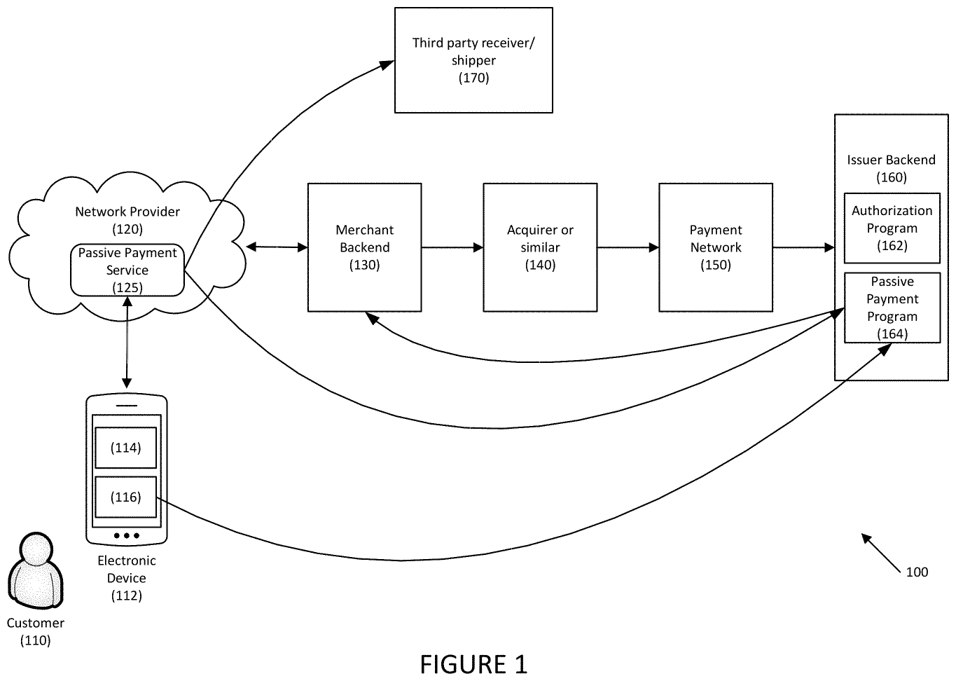

Referring to FIG. 1, a system for inline passive payment with anonymous shipping according to one embodiment. System 100 may include a customer associated with one or more electronic devices 112. Electronic devices 112 may include smart devices (e.g., smart phones, smart watches, etc.), computers (e.g., workstations, desktops, laptops, notebooks, tablets, etc.), Internet of Things (IoT) appliances, etc.

Electronic device 112 may execute one or more computer programs or applications, such a merchant application or browser 114 and passive payment application 116. Merchant application or browser 114 may interact with merchant backend 130 via network provider 120. Customer 110 may select items to purchase using merchant application or browser 114.

Passive payment application 116 may interface with passive payment program 164 provided by issuer backend 160. Customer 110 may set payment preferences, shipping preferences, etc. using passive payment application 116, and these preferences may be communicated to and stored by passive payment program 164.

Network provider 120 may be any suitable network provider, including mobile network operators, internet service providers, etc. Network provider 120 may provide passive payment service 125 that may intercept communications from merchant application or browser 114 en route to merchant backend 130. Passive payment service 125 may provide anonymity services to customer 110, and may permit payment to be made anonymously using a unique identifier for the customer that is generated by passive payment service 125 and/or passive payment program 164.

In one embodiment, passive payment service 125 may generate the unique identifier and provide the unique identifier and customer information to passive payment program 164. In another embodiment, passive payment service 125 may provide customer information to passive payment program 164, and passive payment program may generate or provide the unique identifier to passive payment service 125.

Passive payment service 125 may further provide shipping information to third-party receiver/shipper 170. Third-party receiver/shipper 170 may provide a service where purchases may be shipped to third-party receiver/shipper 170 and held for pickup by customer 110. Third-party receiver/shipper 170 may also ship the purchase to an address of record for customer 110.

Passive payment service 125 may be a use an always-on VPN to plug into existing network infrastructure at network provider 120. In embodiments, passive payment service 125 may be supported using a local proxy or plug-in on electronic device 112 that communications with merchant backend 130 on behalf of issuer backend 160.

Passive payment service 125 may be implemented in hardware, and may be provided as a hardware appliance that interfaces with network provider 120. In another embodiment, passive payment service 125 may comprise a computer program executed on a server, in the cloud, etc. In another embodiment, passive payment service 125 may be distributed between electronic device 112 and network provider 120.

In another embodiment, passive payment service 125 may be provided as a browser plugin that injects the unique id into the header of the http(s) request from the browser. The unique value may rotate for each request to avoid tracking. Merchant backend 130 may call a service (not shown) provided by issuer backend 160 to validate the unique identifier. A browser popup may be provided to confirm the usage of the unique identifier to prevent it from being skimmed.

In embodiments, the unique identifier may guarantee to merchant backend 130 that the anonymous customer is a real person that has been verified (e.g., undergone Know Your Customer verification) by issuer backend 160, and is not on a prohibited list, such as the Office of Foreign Asset Control sanctions list, etc. Thus, embodiments may assist merchant backend 130 in avoiding bots or other automated attacks.

Merchant backend 130 may interface with acquirer or similar 140, which may interface with payment network 150. Payment network 150 may interface with issuer backend 160. Instead of providing a payment instrument, such as a credit card number, token, etc., to acquirer 140, merchant backend 130 may provide the unique identifier, which may be provided to issuer backend 160 by acquirer 140 and payment network 150.

In one embodiment, the unique identifier may be exchanged for a token (e.g., a limited use, one-time use, etc.) that may be used to make the payments using, for example, payment network tokenization.

Issuer backend 160 may authorize a transaction received over payment network 150 using authorization program 162.

In addition to the network provider or always on VPN a browser plugin could be provided that would inject the unique id into the header of the http(s) request from the browser. This would require the unique value to rotate for each request to avoid tracking and the merchant would need to call a bank provided service to validate the id and we would need to also provide a in browser popup to confirm the usage of the code to prevent someone from skimming it from the request and pretending to be the true customer.

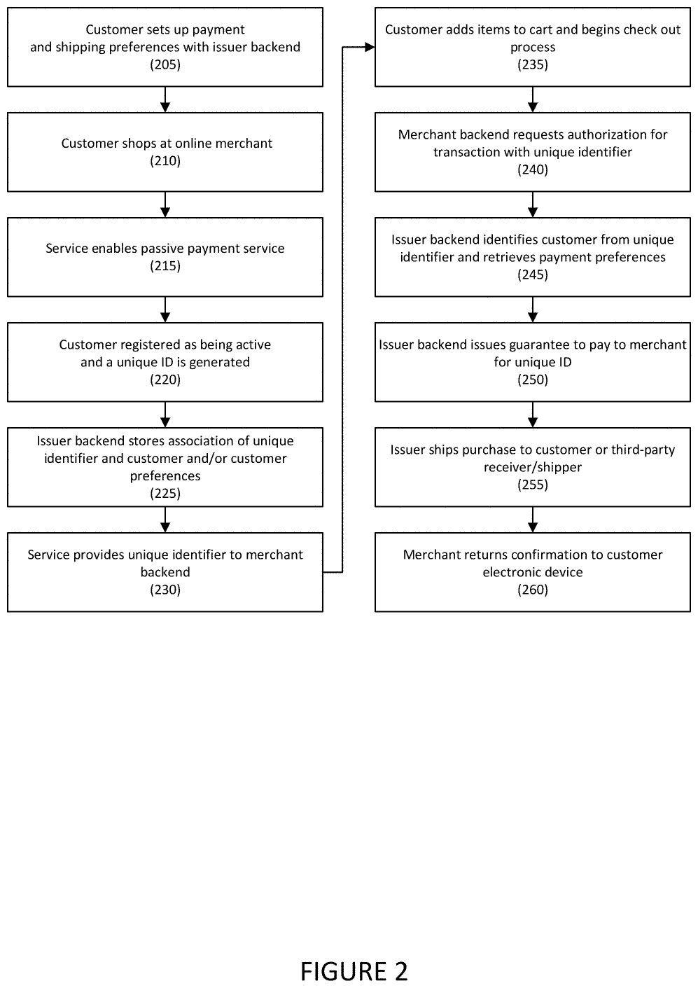

Referring to FIG. 2, a method for inline passive payment with anonymous shipping according to one embodiment.

In step 205, the customer may set up payment and shipping preferences with an issuer backend. For example, the customer may enter these preferences using a passive payment application executed on a user electronic device, such as a smart device, a computer, an IoT appliance, etc. The preferences may be for a single transaction, a single day, a certain time period, a single merchant, website, or application, etc. In another embodiment, the preferences may persist until the customer changes them. Any suitable duration and/or restriction on the preferences may be used as is necessary and/or desired.

In one embodiment, the customer may prefer to remain anonymous to the merchant and may use a third-party shipping address for the purchase. The merchant may ship the purchase to the third-party shipping address, and then the purchase may be made available for pickup by the customer. The third party may also forward the purchase to the customer's shipping address after it is received from the merchant.

In step 210, the customer may begin an interaction with a merchant using a merchant application or browser on the user's electronic device. The electronic device may communicate with the merchant backend via a network provider, such as a mobile network operator or internet service provider.

In step 215, a passive payment service executed by the network provider may identify the customer based on an identifier for the customer's electronic device and may enable a passive payment process.

In embodiments, the passive payment service may intercept the network traffic from the customer's electronic device and determine whether the customer is on a participating merchant's website and to enable the passive payment features. The network traffic may be intercepted, for example, using an always-on VPN, by plugging in to existing network infrastructure at internet service providers or mobile network operators, etc. In cases where the network injection is not possible, the functionality may be supported using a local proxy or plug-in on the user's electronic device that communications with the merchant on behalf of the issuer.

In step 220, the passive payment service may register the customer as an active customer, and may generate a unique identifier for the customer and provide the unique identifier and customer information to the passive payment program at the issuer backend. In another embodiment, the passive payment service may provide the customer information to the passive payment program and may receive a unique identifier for the customer from the passive payment program.

In step 225, the passive payment program may store an association between the unique identifier and the customer. In one embodiment, the passive payment program may further associate the unique identifier with the customer's preferences.

In step 230, instead of providing a customer name, email address, or other identifier for the customer, the passive payment service may anonymize the communication by removing any such identifiers and may provide the unique identifier to the merchant. The unique identifier maintains the anonymity of the customer to merchant. For example, the passive payment service may anonymize the customer, the customer's electronic device, etc. and may route the communication to merchant with the unique identifier. The customer information may be obscured, redacted, modified, or replaced with other information as is necessary and/or desired.

In one embodiment, the unique identifier may be inserted into a https request to the merchant for later use. The unique identifier may be unique per transaction so that the merchant cannot build a profile of identifiers.

In one embodiment, the unique identifier may have a format similar to that of a credit card. In one embodiment, the Bank Identification Number (e.g., the first six digits) may identify the unique identifier as a unique identifier and not a payment instrument to the issuer backend.

In step 235, the customer may add one or more items to an online shopping cart and may begin the checkout process.

In step 240, the merchant may request authorization for the transaction with the issuer backend via the acquirer and payment network. Instead of providing a payment instrument, the merchant may provide the unique identifier to the issuer backend.

In step 245, the issuer backend may identify the customer from the unique identifier and may retrieve the customer's payment preferences.

In step 250, the issuer backend may issue the merchant backend a guarantee to pay for the purchase for the unique identifier. In one embodiment, this message may be provided in a separate communication from the issuer backend to the merchant backend (e.g., outside of the payment network), or it may be provided by the normal path (e.g., from the issuer backend, to the payment network, to the acquirer, and to the merchant backend. The merchant may match the message to the transaction using the unique identifier.

In another embodiment, the issuer backend may issue a single use number (e.g., a one-time credit card number) for the transaction. In another embodiment, the issuer may settle using an ACH transaction, by sending a check, by transferring funds from the customer's account to the merchant account (e.g., if the merchant is also a customer of the issuer), etc.

In one embodiment, the issuer may guarantee the merchant that the customer is valid and has been through all required checks (e.g., know your customer checks, OFAC, etc.). The financial institution may also store the details of the transaction for audit and any other purposes.

In step 255, the issuer backend may provide the customer's shipping information to the merchant backend and the merchant backend may ship the purchase to the customer. In another embodiment, the issuer backend may provide the address of a third-party receiver/shipper to the merchant backend, and the merchant backend may ship the purchase to the third-party receiver/shipper. The third-party shipper/receiver may receive the purchase and may hold it for pickup or may ship the purchase to the customer's address.

Examples of such shipping processes are disclosed in U.S. patent application Ser. No. 17/487,808, filed Sep. 28, 2021, and U.S. Provisional Patent Application Ser. No. 63/085,010, filed Sep. 29, 2020, the disclosures of which are hereby incorporated, by reference, in their entireties.

In step 260, the merchant backend may return a confirmation that the transaction is complete to the customer electronic device. In one embodiment, the service may inject the customer's payment credentials into the merchant's checkout page as the page is being returned to the browser or the merchant application. This may include, for example, the payment credentials, billing and shipping addresses, etc.

In one embodiment, if the items in the cart are saved, payment may be triggered at a later time using, for example, an Internet of Things (“IoT”) device such as a smart speaker. If the IoT device is on the same network and receives an instruction to pay for the saved items, the network provider may identify the instruction and initiate the payment process.

In embodiments, the customer may authenticate to the network, VPN, or other mechanism using, for example, userid and password, out of band authentication, biometric security, etc. to ensure the customer using the device owns the accounts being served up by the passive payment system.

In embodiments, groups (e.g., families), buildings (e.g., households), etc. may be registered with spending limits being placed on different devices or types of internet traffic. In embodiments, real-time confirmation may be sent to the account owner when a family member starts shopping to confirm the family member's authorization to use the passive payment process. If it is not allowed, that may be indicated, and checkout processes will return to a traditional payment process.

In embodiments, the unique identifier may also be used with offers and advertising, such as intent-based offers. An example of such is provided in U.S. Provisional patent application Ser. Nos. 16/845,937, 62/833,417, and Ser. No. 16/844,560, the disclosures of which are hereby incorporated, by reference, in their entireties. The unique identifier may be used to allow the merchant to put a hold on their merchandise as they know the shopper (who may be anonymous) has the ability to pay.

Embodiments may provide a proxy know your customer and shipping process. Because the issuer knows the customer (the merchant may not), the issuer may take on the responsibility for confirming the person shopping has been properly identified. If checkout is done with the unique identifier or a virtual card number, the merchant will not know the true payment credential and the issuer could setup a drop shipment to a reshipping facility, a post office box, etc. to enable full privacy and prevent the merchant from knowing the customer's name or address.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for inline passive payment, comprising:
identifying, at a passive payment service computer program, a communication from an electronic device associated with a customer for a merchant backend;
intercepting, by the passive payment service computer program, the communication;
generating, by the passive payment service computer program, a unique identifier for the communication;
communicating, by the passive payment service computer program, the unique identifier to an issuer backend associated with the customer;
anonymizing, by the passive payment service computer program, the customer and/or the electronic device in the communication; and
routing, by the passive payment service computer program, the anonymized communication to the merchant backend with the unique identifier;
wherein the merchant backend is configured to request payment for a transaction involving the electronic device by providing transaction information and the unique identifier to the issuer backend, and the issuer backend is configured to issue a guarantee of payment for the merchant backend for the transaction using the unique identifier.

2. The method of claim 1, wherein the passive payment service computer program is executed by a network provider comprising a mobile network operator.

3. The method of claim 2, wherein the passive payment service computer program is executed by a network provider comprising an internet service provider.

4. The method of claim 1, wherein the passive payment service computer program comprises a browser plugin for a browser executed on the electronic device.

5. The method of claim 4, wherein the browser plugin injects the unique identifier into a header of a http(s) request from the browser to the merchant backend.

6. An electronic device, comprising:
a memory storing a passive payment service computer program; and
a computer processor;
wherein the passive payment service computer program causes the computer processor to:
identify a communication from an electronic device associated with a customer for a merchant backend;
intercept the communication;
generate a unique identifier for the communication;
communicate the unique identifier to an issuer backend associated with the customer;
anonymize the customer and/or the electronic device in the communication; and
route the anonymized communication to the merchant backend with the unique identifier.

7. The electronic device of claim 6, wherein the electronic device is part of a network provider comprising a mobile network operator.

8. The electronic device of claim 6, wherein the electronic device is part of a network provider comprising an internet service provider.

9. The electronic device of claim 6, wherein the passive payment service computer program comprises a browser plugin for a browser executed on the electronic device.

10. The electronic device of claim 9, wherein the browser plugin injects the unique identifier into a header of a http(s) request from the browser to the merchant backend.

11. A system comprising:
an electronic device;
a network provider comprising a passive payment service computer program;
a merchant backend; and
an issuer backend comprising an passive payment computer program and authorization computer program;
wherein:
the passive payment service computer program identifies a communication from the electronic device associated with a customer for the merchant backend;
the passive payment service computer program intercepts the communication;
the passive payment service computer program generates a unique identifier for the communication;
the passive payment service computer program communicates the unique identifier to an issuer backend associated with the customer;
the passive payment computer program stores an association between customer information for the customer and the unique identifier;
the passive payment service computer program anonymizes the customer and/or the electronic device in the communication;
the passive payment service computer program routes the anonymized communication to the merchant backend with the unique identifier;
the authorization computer program receives, from the merchant backend via a payment network, an authorization request for a transaction comprising transaction information and the unique identifier;
the authorization computer program retrieves the customer information associated with the unique identifier decisions the authorization request;
the authorization computer program provides a payment guarantee for the transaction to the merchant backend; and
the merchant backend completes the transaction.

12. The system of claim 11, wherein the passive payment computer program further communicates shipping information to the merchant backend.

13. The system of claim 12, wherein the shipping information comprises anonymized shipping information.

14. The system of claim 13, wherein the anonymized shipping information comprises a third-party address.

15. The system of claim 11, wherein the electronic device is part of a network provider comprising a mobile network operator.

16. The system of claim 11, wherein the electronic device is part of a network provider comprising an internet service provider.

17. The system of claim 11, wherein the passive payment service computer program comprises a browser plugin for a browser executed on the electronic device.

18. The system of claim 17, wherein the browser plugin injects the unique identifier into a header of a http(s) request from the browser to the merchant backend.

19. The system of claim 11, further comprising a second electronic device that is registered to the customer, wherein the second electronic device completes the transaction initiated with the electronic device.

20. The system of claim 19, wherein the second electronic device is registered to a family member of the customer.
